(19) United States
(12) Patent Application Publication
(10) Pub. No.: US 2004/0091149 A1
(43) Pub. Date: May 13, 2004

(54) Method for uniformizing output image color of a printing device and original color

(76) Inventors: Peng-Cheng Lai, Banchiau City (TW); Yu-Chang Chang, Hsinchu City (TW); Jyh-Wen Huang, Sansia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/699,924

(22) Filed: Nov. 4, 2003

(30) Foreign Application Priority Data
Nov. 5, 2002 (TW) 91132550

(51) Int. Cl. G06K 9/00; H04N 1/407

(52) U.S. Cl. 382/167; 358/3.27

(57) ABSTRACT

A method for uniformizing the output image colors of a printing device and the original colors is proposed. A computer system outputs a set of color patch print signals to a printing device for printing out a color patch diagram. Next, a digital still camera is used to photograph the color patch diagram and then output a color image signal. The computer system converts the color image signal into a CIE XYZ chrominance signal according to an ICC profile of the digital still camera and then processes the CIE XYZ chrominance signal with the set of color patch print signals to obtain an ICC profile of the printing device, or the color image signal and the set of color patch print signals are processed to obtain a relative ICC profile of the digital still camera and the printing device, thereby facilitating color management and calibration and accomplish the advantages of low cost, simple operation and high practicability.

### FIELD OF THE INVENTION

The present invention relates to a digital color management method and, more particularly, to a method making use of a digital still camera to capture an ICC profile of a printing device for uniformizing the printed colors and the original colors.

### BACKGROUND OF THE INVENTION

Along with popularity of digital still cameras and printers, users have higher and higher requirements for image colors. However, there still are differences between color presentations of digital still cameras and printers and actual colors. Moreover, different color presentations exist between different output and input devices of digital images. Therefore, how to let printed-out colors of printers of different brands and specifications more approach original colors is a big problem to be solved urgently.

International color consortium (ICC) is an organization jointly built by international well-known manufacturers. It integrates all image file formats used today and defines out device profiles. That is, ICC profiles are produced when various input equipments like scanners and digital still cameras, display equipments like screens, and printing equipments like printers and printing machines undergo a certain calibration process. Different equipments can thus perform different color conversions based on these ICC profiles to accomplish color management meeting the requirements of users.

Conventionally, the generation of an ICC profile of printer relies on calorimeters sold by manufacturers like X-Rite to obtain more accurate ICC profile data. However, these colorimeters are expensive, and are difficult to operate. It is necessary to use a colorimeter to measure in order every color patch strip to obtain the required ICC profile data, hence deterring common users.

Accordingly, the present invention aims to propose a method for calibrating the output image colors of a printing device to accomplish the object of quick generation of the ICC profile of a printer without the need of any expensive and cumbersome colorimeter.

### SUMMARY OF THE INVENTION

The primary object of the present invention is to provide a method for uniformizing the output image colors of a printing device and the original colors. A digital still camera and its ICC profile are used to generate an ICC profile of the printing device. The original image colors can thus be reproduced through an ICC color management system. The ICC profile of the printing device can be generated using simple operations without any expensive colorimeter.

Another object of the present invention is to provide a method for uniformizing the output image colors of a printing device and the original colors. When a digital still camera has no corresponding ICC profile, the digital still camera photographs an output color image of a printing device to find the relationship between the input signal of the digital still camera and the output signal of the printing device for generating a relative ICC profile, hence accomplishing color management in a quick and simple way.

Yet another object of the present invention is to provide a method for uniformizing the output image colors of a printing device and the original colors. The generated equipment ICC profile not only applies to digital still cameras and printing devices of various brands, but also has the advantages of low cost, high practicability and high accuracy of color reproduction.

According to the present invention, first, a computer system outputs a set of color patch print signals to a printing device for printing out a color patch diagram. A digital still camera having an ICC profile is used to photograph the color patch diagram and then output a color image signal. Next, the computer system converts the color image signal into a CIE XYZ chrominance signal according to the ICC profile of the digital still camera. Subsequently, the computer system processes the CIE XYZ chrominance signal and the set of color patch print signals to obtain an ICC profile of the printing device. The ICC profile of the printing device can then be copied into an ICC-compatible image software for color management and calibration.

If the digital still camera has no corresponding ICC profile, after it photographs the color patch diagram, the computer system will directly process the photographed color image signal and the set of color patch print signals to find the relationship between the input color signal of the digital still camera and the output color signal of the printing device. A relative ICC profile can thus be generated according the relationship for color management and calibration.

The various objects and advantages of the present invention will be more readily understood from the following detailed description when read in conjunction with the appended drawing, in which:

### BRIEF DESCRIPTION OF THE DRAWINGS

FIG. 1 is a diagram showing a method for generating an ICC profile of a printing device of the present invention;

FIG. 2 is a diagram showing a method of using the ICC profile generated in FIG. 1 for color management;

FIG. 3 is a diagram showing a method of generating a relative ICC profile of a digital still camera and a printing device of the present invention; and

FIG. 4 is a diagram showing a method of using the relative ICC profile generated in FIG. 3 for color management.

### DETAILED DESCRIPTION OF THE PREFERRED EMBODIMENTS

In the present invention, a digital still camera and its ICC profile are used as a colorimeter for generating an ICC profile of a printing device. A digital still camera and a printing can also be treated as a system to find out the relationship between the input signal of the digital still camera and the output signal of the printing device for generating a relative ICC profile, hence accomplishing color management and calibration.

Generally speaking, based on different designs of printing devices of various brands, signals received by a printing device can be classified into two modes: RGB and CMYK. RGB represents abbreviations of red (R), green (G) and blue (B), the three primary colors of light. CMYK represents a color subtraction and mixture system based on the three primary colors of colorants, and represents four primary colors for color printing. CMYK represents abbreviations of cyan (C), magenta (M), yellow (Y) and black (K). K not only represents black, but also represents key (K).

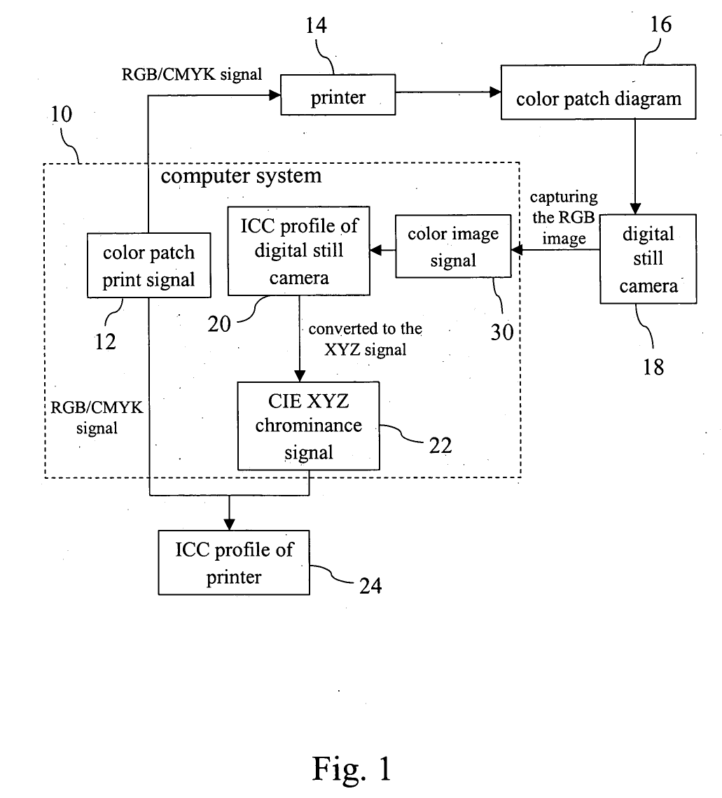

As shown in FIG. 1, first, a computer system 10 outputs a set of color patch print signals 12 to a printing device for printing out a color patch diagram 16. The printing device is usually a printer or a printing machine. The following will be exemplified with a printer 14. The set of color patch print signals are predetermined values inputted to the printer 14 for printing out the color patch diagram 16. The set of color patch print signals 12 are usually signals of the RGB or CMYK mode. The following will be exemplified with the RGB mode.

After the color patch diagram 16 is printed out, a digital still camera 18 having an ICC profile is used to photograph the color patch diagram 16 in a uniform light source to obtain an RGB image, which is transferred to the computer system 30 to obtain a color image signal 30. The computer system 10 then converts the RGB color image signal 30 into a CIE XYZ chrominance signal 22 according to the ICC profile of the digital still camera 18. CIE is a standard coordinate of chrominance. The object of the above operation is to convert the equipment-dependent RGB color space into the equipment-independent CIE XYZ color space for quantization. Next, the computer system 10 processes the CIE XYZ chrominance signal 22 and the set of RGB color patch print signals 12 to obtain an ICC profile 24 of the printer 14. The ICC profile 24 of the printer 14 can then be copied into an ICC-compatible image software for color management and calibration.

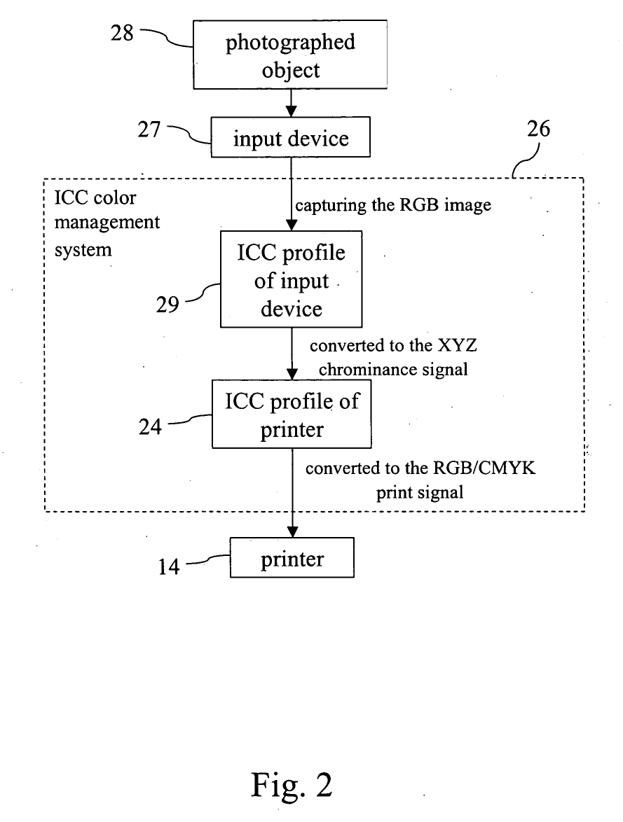

As shown in FIG. 2, an input device 27 is used to capture a photographed object 28 for obtaining its RGB image. The input device 27 is a device capable of capturing images like a digital still camera or a scanner. The input device 27 itself has a corresponding ICC profile 29. Next, the ICC profile 29 of the input device 27 is copied into an ICC color management system 26, which can capture the RGB image of the photographed object 28 through the ICC profile 29 of the input device 27 and then convert into a CIE XYZ chrominance signal. Subsequently, the CIE XYZ chrominance signal is converted into an RGB print signal according to the ICC profile 24 of the printed 14 and outputted to the printer 14. The printer can then print out the image according to the RGB print signal, hence uniforming the output image colors of the printer 14 and the input colors of the digital still camera 18.

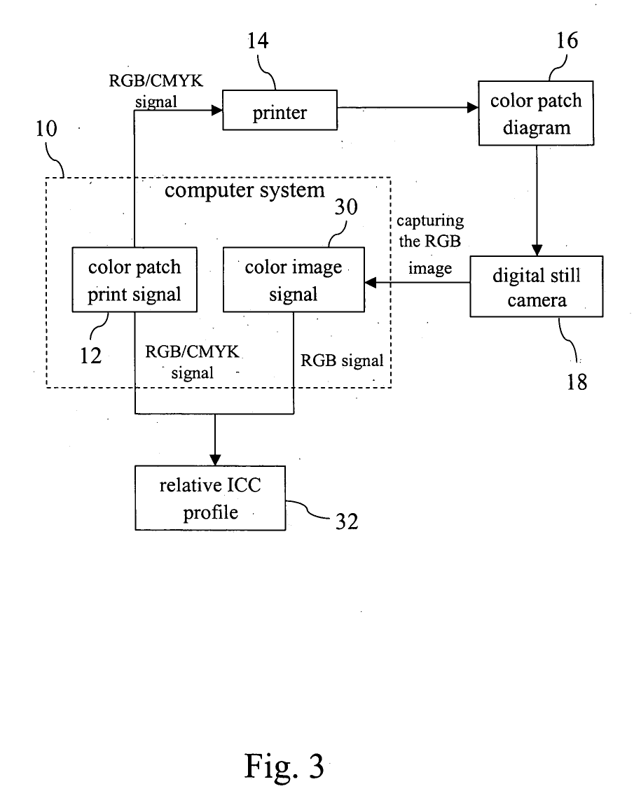

Besides, if the digital still camera 18 has no ICC profile, as shown in FIG. 3, the computer system 10 similarly outputs a set of RGB color patch print signals 12 to the printer 14 for printing out a color patch diagram 16. The digital still camera 18 is then used to photograph the color patch diagram 16 in a uniform light source to obtain an RGB color image, which is transferred to the computer system 10 for obtaining a color image signal 30. Next, the computer directly processes the RGB color image signal 30 and the set of RGB color patch print signals 12 to find out the relationship between the input color signal (RGB) of the digital still camera 18 and the output color signal (RGB/CMYK) of the printer 14. Based on this relationship, a relative ICC profile 32 can be generated. The relative ICC profile can be further copied into a color management software for color management and calibration.

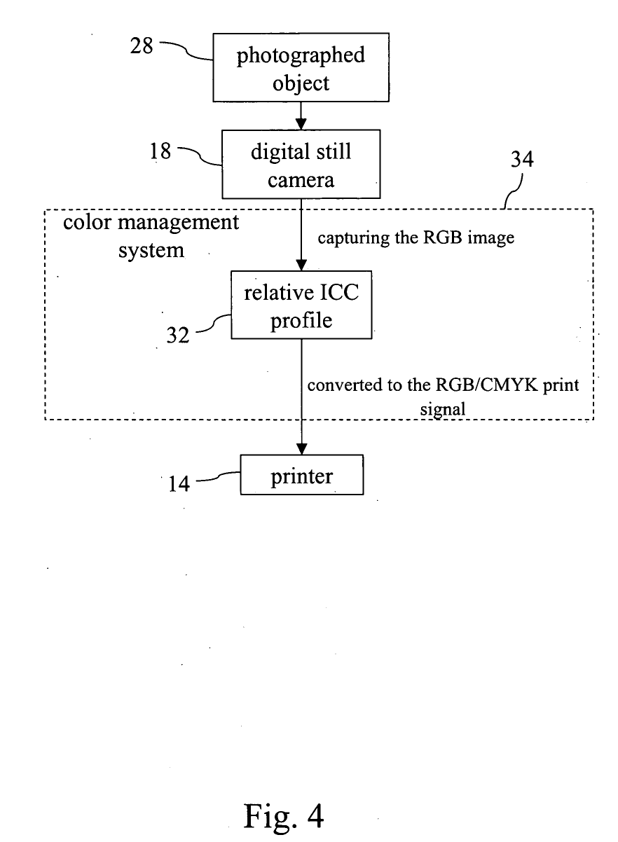

As shown in FIG. 4, the digital still camera 18 is used to photograph an object 28 to obtain an RGB image of the photographed object 28. The color management system 28 then captures the RGB signal and converts it into an RGB print signal according to the relative ICC profile 32. The RGB print signal is outputted to the printer 14. The printer 14 can then print out the image according to the RGB print signal, hence uniforming the output image colors of the printer 14 and the input colors of the digital still camera 18.

To sum up, in the present invention, a digital still camera and its ICC profile are used for generating an ICC profile of a printing device through operations of a computer system, or a digital still camera and a printing device are treated as a system for obtaining the relationship between the input color signal of the digital still camera and the output color signal of the printing device through operations of a computer system, thereby facilitating subsequent processing like color management and calibration. An ICC profile of a printing device can be generated for uniformizing the output image colors of the printing device and the original colors in a quick and simple way without any expensive calorimeter. The present invention not only applies to digital still cameras and printing devices of various brands, but also has the advantages of low cost, high practicability, and high accuracy of color reproduction.

Although the present invention has been described With reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method for uniformizing the output image colors of a printing device and the original colors, comprising the steps of:
using a computer to output a set of color patch print signals to a printing device for printing out a color patch diagram;
using a digital still camera having an ICC profile to photograph said color patch diagram and then output a color image signal;
using said computer to convert said color image signal into a CIE XYZ chrominance signal according to said ICC profile of said digital still camera; and
using said computer system to process said CIE XYZ chrominance signal and said set of color patch print signals to obtain an ICC profile of said printing device, copying said ICC profile of said printing device into an ICC-compatible image software for color management and calibration.

2. The method as claimed in claim 1, wherein said set of color patch print signals comprise signals in the RGB or CMYK mode or other signals specified by a printer.

3. The method as claimed in claim 1, wherein said digital still camera photographs said color patch diagram in a uniform light source.

4. The method as claimed in claim 1, wherein said set of color patch print signals are predetermined values inputted to said printing device for printing out said color patch diagram.

5. The method as claimed in claim 1, wherein when performing color management and calibration, an input device having an ICC profile is used to capture the image of an photographed object and then input to an ICC color management system, said ICC profile of said input device is copied into said ICC color management system to convert the inputted image of said photographed object into a CIE XYZ chrominance signal according to said ICC profile of said input device, said CIE XYZ chrominance signal is then converted into a print signal according to said ICC profile of said printing device and then outputted to said printing device for printing out the image according to said printing signal.

6. The method as claimed in claim 6, wherein said input device is selected from a group comprising a digital still camera and a scanner.

7. A method for uniformizing the output image colors of a printing device and the original colors, comprising the steps of:
using a computer to output a set of color patch print signals to a printing device for printing out a color patch diagram;
using a digital still camera to photograph said color patch diagram and then output a color image signal; and
using said computer system to process said color image signal and said set of color patch print signals to obtain the relationship between the input color signal of said digital still camera and the output color signal of said printing device and generating a relative ICC profile, copying said relative ICC profile into an image management software for color management and calibration.

8. The method as claimed in claim 8, wherein said set of color patch print signals comprise signals in the RGB or CMYK mode or other signals specified by a printer.

9. The method as claimed in claim 8, wherein said digital still camera photographs said color patch diagram in a uniform light source.

10. The method as claimed in claim 8, wherein said set of color patch print signals are predetermined values inputted to said printing device for printing out said color patch diagram.

11. The method as claimed in claim 8, wherein when performing color management and calibration, said relative ICC profile is used to capture an image photographed by said digital still camera, said image is converted into a print signal and then outputted to said printing device for printing out the image according to said printing signal.
